(19) United States
(12) Patent Application Publication
(10) Pub. No.: US 2026/0046693 A1
(43) Pub. Date: Feb. 12, 2026

(54) REAL-TIME RADIO SITE COVERAGE ADJUSTMENT

(71) Applicant: T-Mobile USA, Inc., Bellevue, WA (US)

(72) Inventors: Emile Minh Tran, Sammamish, WA (US); Antoine T. Tran, Bellevue, WA (US); Robert Andrew Berrier, Renton, WA (US); Luis Alberto Uribe Gonzalez, Parsippany, NJ (US); Venu GR Mudunuri, Carrollton, TX (US); Justin R. Mueller, Sammamish, WA (US)

(21) Appl. No.: 18/798,797

(22) Filed: Aug. 8, 2024

(51) Int. Cl. H04W 28/086; H04B 7/06; H04W 28/08; H04W 72/044

(52) U.S. Cl. CPC H04W 28/0861; H04B 7/0695; H04W 28/0835; H04W 72/046

(57) ABSTRACT

Solutions are disclosed that advantageously perform real-time radio site coverage adjustment, such as by adjusting antenna pointing directions, to minimize service disruptions in a wireless network. When a first radio site is unable to meet demand for service, due to a scheduled network service activity, an unplanned outage, or a spike in demand, an antenna at a second radio site (e.g., a neighbor of the first radio site), is aimed (pointed) such that it is the second radio site is able to meet at least a portion of the demand for service of the first radio site. The pointing may be accomplished using mechanical tilt and/or beamforming. This may cascade, such that a third radio site supplements coverage for the second radio site's larger traffic demand. Upon the first radio site's unmet traffic demand abating, the antenna of the second radio site may return to its default pointing direction.

### BACKGROUND

Modern cellular networks typically require network service activities relatively often, such as upgrades (software and hardware), maintenance, and configuration changes, including frequency retuning when new spectrum becomes available. Even relatively quick network service activities may take a base station at a radio site (e.g., a cell site or cell cluster) offline for 10 to 30 minutes, during which time the radio site is unable to provide service to user equipment (UEs) in the vicinity. When a network service activity is performed on all or most radio sites in some market (e.g., the cellular coverage for a metropolitan area) UEs may find themselves in the middle of a “dead zone”, entirely without service, for the duration of a network service activity. Additionally, unplanned outages, such as due to equipment failures and weather events, can take a base station at a radio site (e.g., a cell site or cell cluster) offline. Further, sudden large increases in the number UEs concentrated in the locality of a radio site may drive connection demands above the capacity of the radio site, leaving many UEs without service. These events adversely affect usability and service reliability for large numbers of UEs.

### SUMMARY

The following summary is provided to illustrate examples disclosed herein, but is not meant to limit all examples to any particular configuration or sequence of operations.

Solutions are disclosed that advantageously perform real-time radio site coverage adjustment in order to minimize service disruptions in a wireless network. Examples accomplish this by, based on at least determining that a first radio site is unable to meet demand for service, identify a second radio site that is able to perform a first antenna pointing adjustment to meet at least a portion of the demand for service of the first radio site; determine a first antenna pointing adjustment parameter value for an antenna of the second radio site for meeting the portion of the demand for service of the first radio site; and adjust the antenna of the second radio site from an initial pointing direction to a new pointing direction using the first antenna pointing adjustment parameter value.

### BRIEF DESCRIPTION OF THE DRAWINGS

The disclosed examples are described below with reference to the accompanying drawing figures listed below, wherein:

FIG. 1 illustrates an exemplary architecture that advantageously perform real-time radio site coverage adjustment, such as by adjusting antenna pointing directions, to minimize service disruptions in a wireless network;

FIG. 2 illustrates a plurality of radio sites (e.g., cells or cell clusters), as may exist in examples of the architecture of FIG. 1;

FIG. 3 illustrates examples of neighbor cells, as may occur in examples of the plurality of radio sites of FIG. 2;

FIG. 4 illustrates further detail for aspects of examples of the architecture of FIG. 1;

FIGS. 5A and 5B illustrate demand for service (i.e., network traffic demand), as may occur in examples of the architecture of FIG. 1;

FIGS. 6A, 6B, and 6C illustrate antenna pointing adjustments, as may occur in examples of the architecture of FIG. 1;

FIG. 7 illustrates an exemplary antenna pointing adjustment coverage data set, as may be used in examples of the architecture of FIG. 1;

FIG. 8 illustrates an example timeline of activities associated with real-time radio site coverage adjustment, as may occur in examples of the architecture of FIG. 1;

FIGS. 9 and 10 illustrate flowcharts of exemplary operations associated with the architecture of FIG. 1; and

FIG. 11 illustrates a block diagram of a computing device suitable for implementing various aspects of the disclosure.

Corresponding reference characters indicate corresponding parts throughout the drawings, where practical. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that advantageously perform real-time radio site coverage adjustment, such as by adjusting antenna pointing directions, to minimize service disruptions in a wireless network. When a first radio site is unable to meet demand for service, due to a scheduled network service activity, an unplanned outage, or a spike in demand, an antenna at a second radio site (e.g., a neighbor of the first radio site), is aimed (pointed) such that it is the second radio site is able to meet at least a portion of the demand for service of the first radio site. The pointing may be accomplished using mechanical tilt and/or beamforming.

This may cascade, such that a third radio site supplements coverage for the second radio site's larger traffic demand. Upon the first radio site's unmet traffic demand abating, the antenna of the second radio site may return to its default pointing direction.

Aspects of the disclosure thus improve the performance of wireless (cellular) networks by leveraging neighbor radio sites (cells or cell clusters) to supplement coverage for a radio site that is overwhelmed by traffic demand or out of service, thus avoiding scenarios in which UEs are unable to receive service from any radio site the duration of the network service activity, unplanned outage, or heavy localized demand. This reduces negative impacts on a large number of network users. These advantageous results are accomplished, at least in part by, adjusting an antenna of a second radio site from its initial pointing direction to its new pointing direction using an antenna pointing adjustment parameter value.

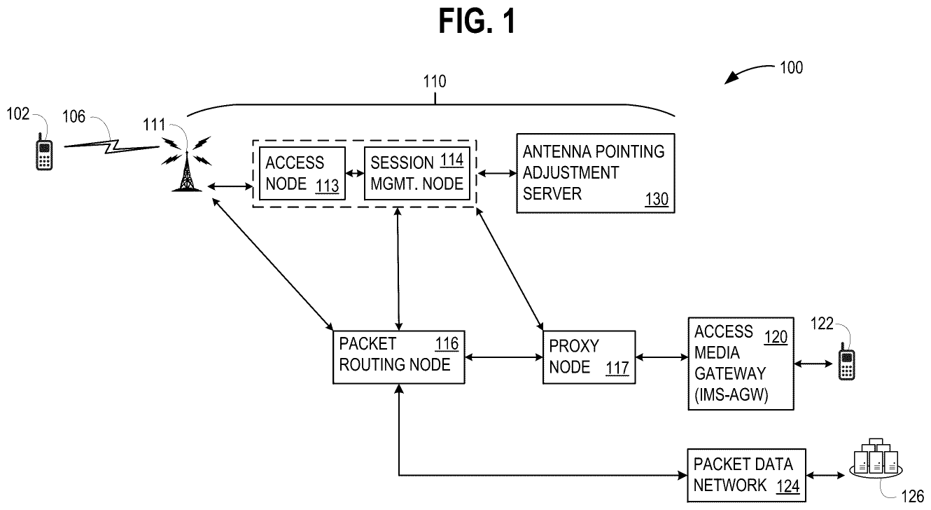

With reference now to the figures, FIG. 1 illustrates an exemplary architecture 100 that advantageously orchestrates network service activities using predicted traffic in order to minimize service disruptions. A wireless network 110 is illustrated that is serving a UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

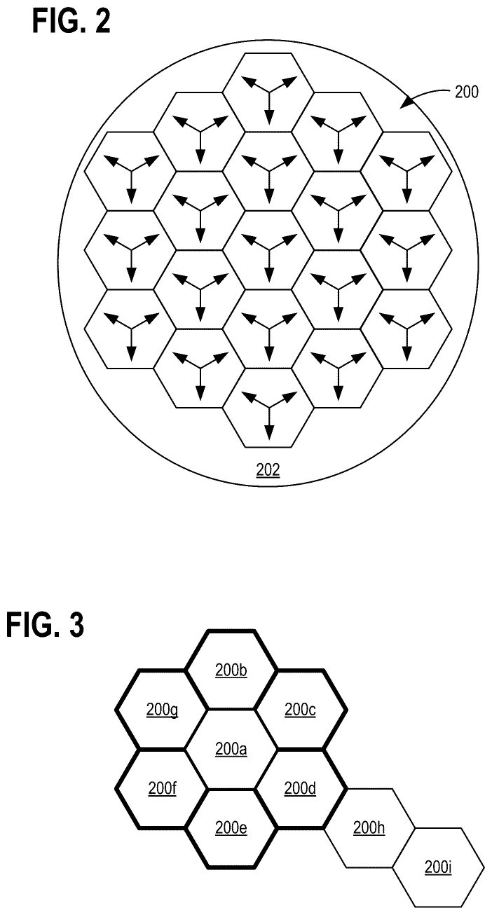

UE 102 uses an air interface 106 to communicate with a base station 111 of wireless network 110, such that base station 111 is the serving base station for UE 102 (providing the serving cell). In some scenarios, base station 111 may be referred to as a radio access network (RAN), and is located at a radio site (See FIG. 2). Wireless network 110 has an access node 113, a session management node 114, and other components (not shown).

Wireless network 110 also has a packet routing node 116 and a proxy node 117. Access node 113 and session management node 114 are within a control plane of wireless network 110, and packet routing node 116 is within a data plane (a.k.a. user plane) of wireless network 110.

Base station 111 is in communication with access node 113 and packet routing node 116. Access node 113 is in communication with session management node 114, which is in communication with packet routing node 116 and proxy node 117. Packet routing node 116 is in communication with proxy node 117 and packet data network 124. In some 5G examples, base station 111 comprises a gNodeB (gNB), access node 113 comprises an access mobility function (AMF), session management node 114 comprises a session management function (SMF), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 117 may be considered to be within the IMS. UE 102 reaches network resource 126 using packet data network 124 (or the IMS, in some examples). Data packets of data traffic to/from UE 102 pass through at least base station 111 and packet routing node 116 on their way from/to packet data network 124 or IMS-AGW 120 (via proxy node 117).

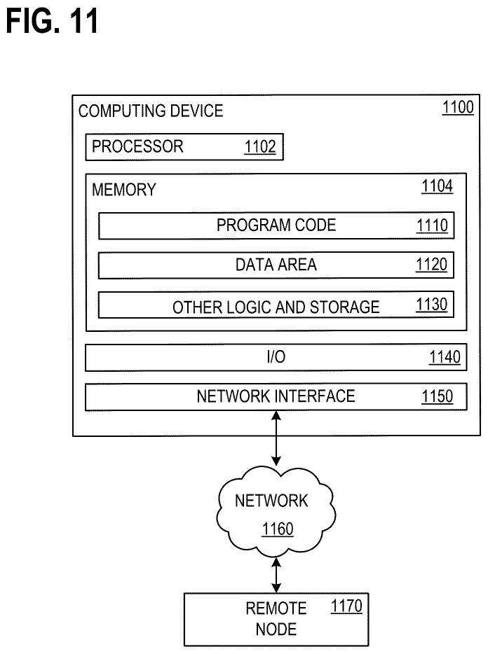

As described more fully below, in relation to the other figures, an antenna pointing adjustment server 130 adjusts antenna pointing direction of radio sites of wireless network 110, such as base station 111. This permits an antenna at a second radio site to change its pointing direction to meet at least a portion of the demand for service of a first radio site (a neighbor radio site), when the first radio site is unable to meet demand for service (e.g., due to a scheduled network service activity, an unplanned outage, or a spike in demand). In some examples, antenna pointing adjustment server 130 is provided as a remote computing service, such as a cloud service available over a computer network 1160 (see FIG. 11). In other examples, antenna pointing adjustment server 130 may be a local computing resource at a network operations center (NOC) of wireless network 110.

Although FIG. 1 and some of the following figures are described using an example of a cellular network, it should be understood that the teachings herein are applicable to other types of wireless networks. To benefit from the teachings herein, another type of wireless network should offer geographically-dispersed radio sites with overlapping and/or adjacent coverage, and antennas that are capable of being remotely aimed, either mechanically (i.e., adjusting antenna pointing or tilt angle with a gimbal), electronically (i.e., with multiple phase centers and phase shifters to steer an array beam as in beamforming). With such a configuration, the teachings herein may extend to the other types of wireless network.

FIG. 2 illustrates a plurality of radio sites 200 in a geographic region 202. Plurality of radio sites 200 are the UE-facing portion of wireless network 110 within geographic region 202, and each radio site of plurality of radio sites 200 may contain one or more base stations, such as base station 111. One or more versions of antenna pointing adjustment server 130 may be used for a single geographic region (or market, such as a metropolitan area).

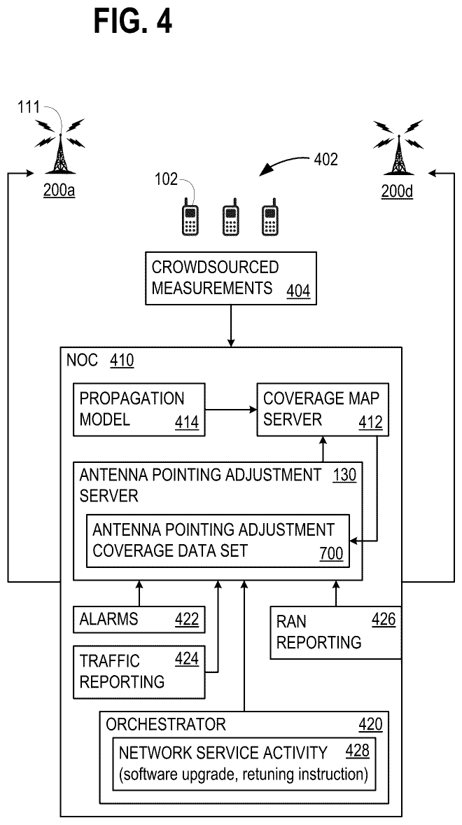

FIG. 3 illustrates a definition of tier 1 neighbors, using radio sites 200a-200i of radio sites 200. A central radio site 200a is surrounded by its tier 1 neighbors: a radio site 200b, a radio site 200c, a radio site 200d, a radio site 200e, a radio site 200f, and a radio site 200g—each of which is immediately adjacent to radio site 200a and thus has an adjacent coverage zone. Because radio sites 200b-200g are tier 1 neighbors of radio site 200a, a UE that is being served by radio site 200a may also have sufficient radio channel quality with one (or more) of radio sites 200b-200g to be served by that radio site when radio site 200a goes offline for network service activity 428. This is an overlapping coverage scenario. A supercell that has a coverage area overlapping with the coverage area of radio site 200a is another overlapping coverage scenario.

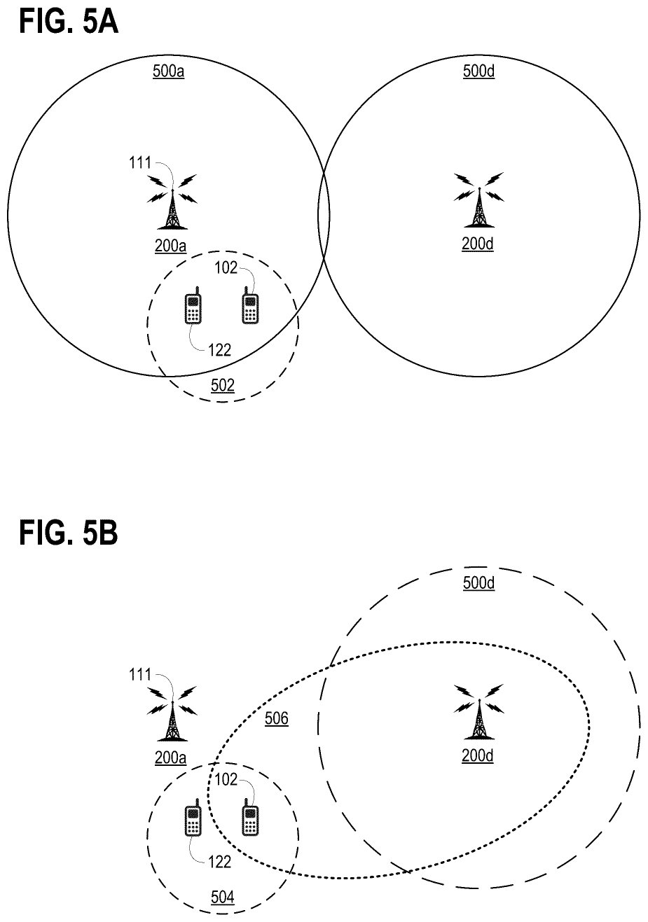

FIG. 4 illustrates further detail for antenna pointing adjustment server 130 and associated functionality. Wireless network 110 has a network operations center 410 (NOC) that services radio sites 200 including radio site 200a, radio site 200d, radio site 200h (not shown), and others. A coverage map server 412 uses a propagation model 414 and crowdsourced radio signal quality measurements 404 from a plurality of UEs 402 (that is illustrated as including UE 102) to generate and maintain antenna pointing adjustment coverage data set 700.

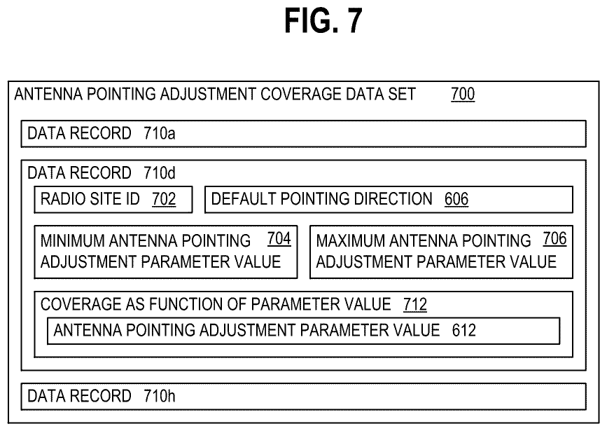

During a charting mode, typically during a period of low network traffic, coverage map server 412 tests various antenna pointing directions for each of radio sites 200, and collects crowdsourced radio signal quality measurements 404 to determine coverage as a function of the tested antenna pointing directions. This information is stored in antenna pointing adjustment coverage data set 700, as described in further detail in relation to FIGS. 7, 8, and 9.

During a response mode, antenna pointing adjustment server 130 uses antenna pointing adjustment coverage data set 700 to perform real-time radio site coverage adjustment, by adjusting antenna pointing directions, to minimize service disruptions in wireless network 110 when a radio site cannot meet demand. In some examples, antenna pointing adjustment server 130 uses a rule driven approach, which may include artificial intelligence (AI, which includes machine learning, ML, as used herein) to identify the amount of antenna pointing direction adjustments. During the response mode, antenna pointing adjustment server 130 may also continue collecting crowdsourced radio signal quality measurements 404 and sending it to coverage map server 412 to update antenna pointing adjustment coverage data set 700.

Antenna pointing adjustment server 130 may receive RAN alarms 422 when radio sites experience unplanned outages, and indications of a planned network service activity 428, that will take a radio site (e.g., radio site 200a) offline, from a RAN orchestrator 420. Network service activity 428 may be an intangible abstraction in some examples (such as an activity of replacing equipment), but is represented in FIG. 4 as a tangible item such as a software upgrade package or frequency retuning instructions.

Additionally, in some examples, antenna pointing adjustment server 130 receives traffic monitoring and prediction 424 that enables determination of how much supplementation is needed (i.e., one radio site changing its antenna pointing direction, or additional radio sites also changing their antenna pointing directions) to compensate and meet the traffic demand. In some examples, even if a radio site is not experiencing an outage (whether planned or unplanned), if it is overwhelmed by demand from a large influx of UEs generating traffic over wireless network 110, traffic monitoring and prediction 424 may indicate to antenna pointing adjustment server 130 that supplementation is nevertheless still needed. Further, in some examples, RAN reporting 426 provides antenna pointing adjustment server 130 with information on current and/or default antenna pointing directions (e.g., tilt angles) for radio sites 200.

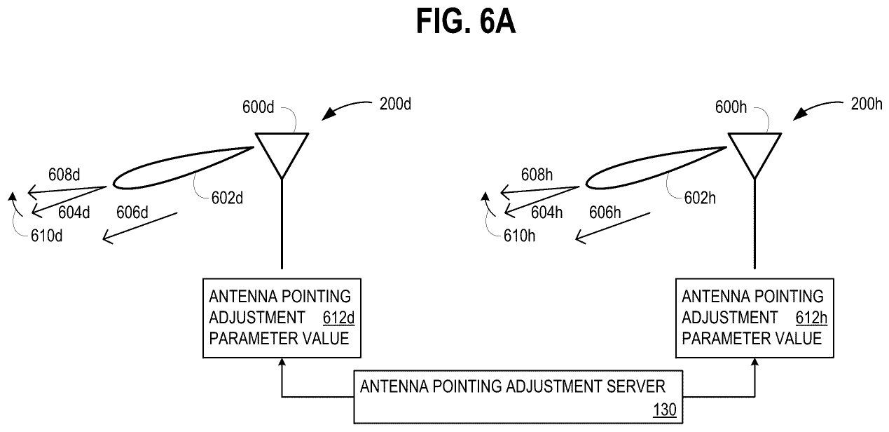

FIG. 5A illustrates demand for service (i.e., network traffic demand) for radio site 200a. Coverage 500a for radio site 200a and coverage 500d for radio site 200d are both shown. Demand for service 502 of radio site 200a is a notional construct, but is represented by the dashed line around UEs 102 and 122. FIG. 5B illustrates unmet demand for service, when radio site 200a is offline. Coverage 500a for radio site 200a has vanished, and unmet demand for service 504 (a notional construct) is represented by the dashed line around UEs 102 and 122. With an antenna pointing adjustment, radio site 200d has new coverage 506 shown by dotted ellipse, that meets a portion of unmet demand for service 504 by including UE 102, although due to changing the antenna pointing direction some of coverage 500d may have been lost. This is dependent on the direction of the pointing direction change, as some antenna pointing direction changes (e.g., tilting upward), may increase coverage without any loss. Other changes (e.g., beamforming) are more likely to cause some directionally-dependent loss of coverage.

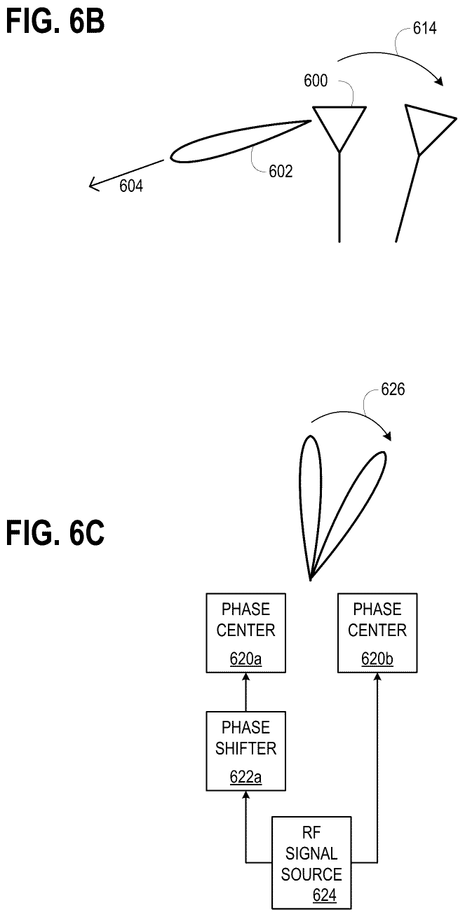

FIG. 6A illustrates antenna pointing adjustment parameters for radio site 200d and its neighbor, radio site 200h. Radio site 200d has an antenna 600d with a main lobe 602d in an initial pointing direction 604d, which may be the same as (or different than) its default pointing direction 606d. An antenna pointing adjustment 610d moves main lobe 602d into a new pointing direction 608d, based on an antenna pointing adjustment parameter value 612d received from antenna pointing adjustment server 130.

Similarly, radio site 200h has an antenna 600h with a main lobe 602h in an initial pointing direction 604h, which may be the same as (or different than) its default pointing direction 606h. An antenna pointing adjustment 610h moves main lobe 602h into a new pointing direction 608h, based on an antenna pointing adjustment parameter value 612h received from antenna pointing adjustment server 130.

FIG. 6B illustrates a scenario using a mechanical antenna pointing adjustment, in either tilt or azimuth (although both can occur, simultaneously). An angle change 614 changes the tilt (or azimuth pointing direction) of an antenna 600, which may be antenna 600d or 600h, or an antenna at another radio site. The tilt change causes main lobe 602 to change from its initial pointing direction 604. Angle change 614 generically represents any of a tilt angle, a tilt angle change, an azimuth angle and an azimuth angle change. Mechanical antenna pointing adjustments may use a gimbal.

FIG. 6C illustrates a scenario using an electrical antenna pointing adjustment, in either tilt or azimuth (although both can occur, simultaneously). Electrical antenna pointing adjustments may be accomplished using beamforming on an antenna array comprising displaced phase centers 620a and 620b. A phase shifter 622a feeds phase center 620a, and provides a phase shift of the radio frequency (RF) signal arriving from (or sent to) an RF signal source 624 (or a receiver). In some examples, phase center 620b also has a phase shifter. An angle change 626 generically represents any of a tilt angle, a tilt angle change, an azimuth angle and an azimuth angle change.

FIG. 7 illustrates further detail for antenna pointing adjustment coverage data set 700. Antenna pointing adjustment coverage data set 700 has data records for each radio site of radio sites 200, such as a data record 710a for radio site 200a, a data record 710d for radio site 200d, and a data record 710h for radio site 200h. Data record 700d is shown in further detail; the other data records are similar.

Data record 700d has a radio site ID 702 identifying the radio site (in this example, radio site 200d), a default pointing direction identified generally as default pointing direction 606, a minimum antenna pointing adjustment parameter value identified generally as minimum antenna pointing adjustment parameter value 704, and a maximum antenna pointing adjustment parameter value identified generally as maximum antenna pointing adjustment parameter value 706. Data record 700d also has radio coverage 712 as a function of antenna pointing adjustment parameter value (identified generally as antenna pointing adjustment parameter value 612). For radio site 200d, antenna pointing adjustment parameter value 612 is sent to radio site 200d as antenna pointing adjustment parameter value 612d of FIG. 6A.

Radio coverage 712 is determined as a function of antenna pointing adjustment parameter value 612 from minimum antenna pointing adjustment parameter value 704 up through maximum antenna pointing adjustment parameter value 706, possibly with intermediate values also measured. For example, antenna 600d may be placed at its minimum tilt angle (most downward), and crowdsourced radio signal quality measurements 404 are collected to determine radio coverage 712 at that minimum tilt angle. Antenna 600d is tilted upward some amount, and crowdsourced radio signal quality measurements 404 are collected to determine radio coverage 712 at that tilt angle. This is repeated until antenna 600d is placed at its maximum tilt angle (most practical upward tilt angle, determined to give the maximum range), and crowdsourced radio signal quality measurements 404 are collected to determine radio coverage 712 at that maximum tilt angle. Radio coverage 712 is stored, with whatever azimuth radio signal quality information is available from crowdsourced radio signal quality measurements 404, at each of the measured tilt angles. AI uses this stored information to predict radio coverage at angles that may not have been measured.

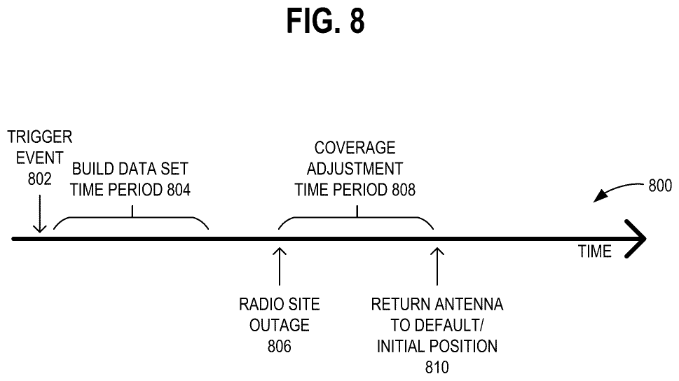

FIG. 8 illustrates a timeline 800 of activities associated with real-time radio site coverage adjustment. Timeline 800 starts with a trigger event 802 for building antenna pointing adjustment coverage data set 700, such as a low traffic condition. Trigger event 802 may be network wide, individual to each radio site, or some mixture. A time period 804 is when wireless network 110 is in charting mode and is building antenna pointing adjustment coverage data set 700.

A radio site outage (e.g., for radio site 200a) occurs at event 806, and wireless network 110 enters response mode during a time period 808, in which one or more antennas are pointed to compensate for unmet demand. At the end of time period 808 the antennas are returned to their initial or default positions at an event 810.

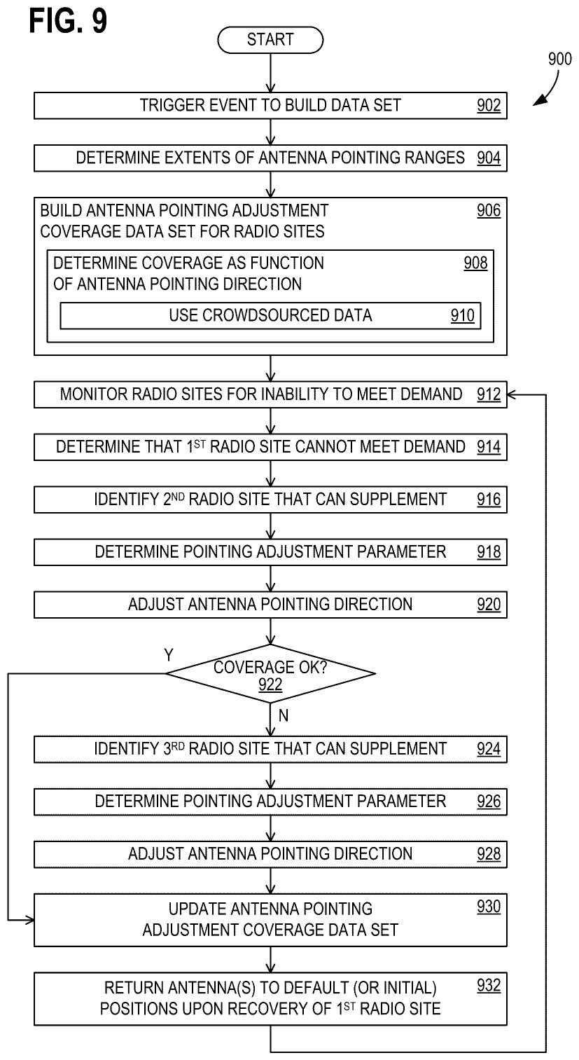

FIG. 9 illustrates a flowchart 900 of exemplary operations associated with architecture 100. In some examples, at least a portion of flowchart 900 may be performed using one or more computing devices 1100 of FIG. 11. Flowchart 900 commences with trigger event 802 for building antenna pointing adjustment coverage data set 700 for radio sites 200 of wireless network 110, in operation 902. That is, building antenna pointing adjustment coverage data set 700 for each radio site included in antenna pointing adjustment coverage data set 700 is based on at least trigger event 802, in some examples.

For each radio site included in antenna pointing adjustment coverage data set 700, Operation 904 determines minimum antenna pointing adjustment parameter value 704 for that radio site and maximum antenna pointing adjustment parameter value 706 for that radio site. Operation 906 builds antenna pointing adjustment coverage data set 700 for plurality of radio sites 200, which includes radio site 200d and radio site 200h, using operations 908 and 910. Operation 908 determines radio coverage 712 as a function of antenna pointing adjustment parameter value 612 from minimum antenna pointing adjustment parameter value 704 for that radio site through maximum antenna pointing adjustment parameter value 706 for that radio site. This may include coverage for that radio site's default pointing direction 606 (generally, which is default pointing direction 606d for radio site 200d and default pointing direction 606h for radio site 200h). This is performed by using crowdsourced radio signal quality measurements 404 in operation 910.

Operation 912 monitor for any radio site to be unable to meet demand for service, such as by an outage (RAN alarms 422), network service activity 428, or excessive traffic exceeding a radio site's service capacity (using traffic monitoring and prediction 424). Operation 914 determines that radio site 200a is unable to meet demand for service, based on the monitoring of operation 912. Based on at least determining that radio site 200a is unable to meet demand for service, operation 916 uses antenna pointing adjustment coverage data set 700 to identifying that radio site 200d is able to perform antenna pointing adjustment 610d to meet at least a portion of the demand for service of radio site 200a. This may be a mechanical antenna pointing adjustment or an electrical antenna pointing adjustment using beamforming, such as a tilt angle adjustment or an azimuth angle adjustment.

Operation 918 determines antenna pointing adjustment parameter value 612d for antenna 600d of radio site 200d for meeting the portion of the demand for service of radio site 200a, such as by using AI, in some examples. Antenna pointing adjustment parameter value 612d may be one or more of a tilt angle, a tilt angle change, an azimuth angle, an azimuth angle change, a beam steering angle, a beam steering angle change, an array element phase, and an array element phase change—or some other suitable parameter. Operation 920 then adjusts antenna 600d of radio site 200d from its initial pointing direction 604d to its new pointing direction 608d, using the antenna pointing adjustment parameter value 612d.

Decision operation 922 determines whether radio site 200d is unable to meet its own demand for service, due to adjusting antenna 600d to new pointing direction 608d. If not, flowchart 900 moves to operation 930. However, if decision operation does determine that radio site 200a is unable to meet demand for service, operation 924 uses antenna pointing adjustment coverage data set 700 to identifying that radio site 200h is able to perform antenna pointing adjustment 610h to meet at least a portion of the demand for service of radio site 200d.

Operation 926 determines antenna pointing adjustment parameter value 612h for antenna 600h of radio site 200h for meeting the portion of the demand for service of radio site 200d. Antenna pointing adjustment parameter value 612h may be one or more of a tilt angle, a tilt angle change, an azimuth angle, an azimuth angle change, a beam steering angle, a beam steering angle change, an array element phase, and an array element phase change—or some other suitable parameter. Operation 928 then adjusts antenna 600h of radio site 200h from its initial pointing direction 604h to its new pointing direction 608h, using the antenna pointing adjustment parameter value 612h.

In operation 930, additional crowdsourced radio signal quality measurements 404 are used to update antenna pointing adjustment coverage data set 700, while antenna 600d of radio site 200d is in its new pointing direction 608d and also, possibly, while antenna 600h of radio site 200h is in its new pointing direction 608h. Upon reduction of unmet demand for service of radio site 200a, operation 932 returns antenna 600d of radio site 200d to its initial pointing direction 604d or its default pointing direction 606d, and may also return antenna 600h of radio site 200h to its initial pointing direction 604h or its default pointing direction 606h. Flowchart 900 then returns to operation 912 to monitor for any additional situations of unmet demand.

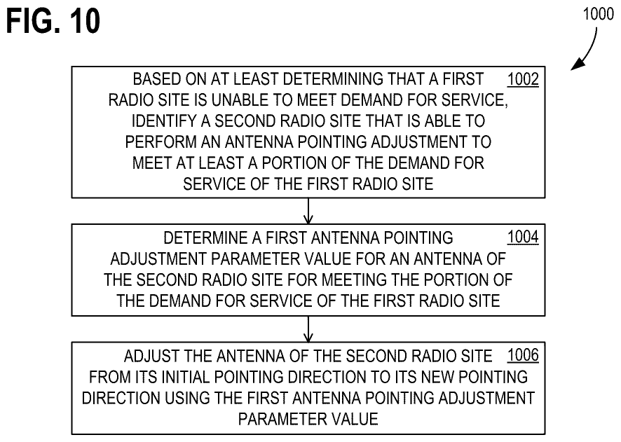

FIG. 10 illustrates a flowchart 1000 of exemplary operations associated with examples of architecture 100. In some examples, at least a portion of flowchart 1000 may be performed using one or more computing devices 1100 of FIG. 11. Flowchart 1000 commences with operation 1002, which includes, based on at least determining that a first radio site is unable to meet demand for service, identifying a second radio site that is able to perform a first antenna pointing adjustment to meet at least a portion of the demand for service of the first radio site.

Operation 1004 includes determining a first antenna pointing adjustment parameter value for an antenna of the second radio site for meeting the portion of the demand for service of the first radio site. Operation 1006 includes adjusting the antenna of the second radio site from an initial pointing direction to a new pointing direction using the first antenna pointing adjustment parameter value.

FIG. 11 illustrates a block diagram of computing device 1100 that may be used as any component described herein that may require computational or storage capacity. Computing device 1100 has at least a processor 1102 and a memory 1104 that holds program code 1110, data area 1120, and other logic and storage 1130. Memory 1104 is any device allowing information, such as computer executable instructions and/or other data, to be stored and retrieved. For example, memory 1104 may include one or more random access memory (RAM) modules, flash memory modules, hard disks, solid-state disks, persistent memory devices, and/or optical disks. Program code 1110 comprises computer executable instructions and computer executable components including instructions used to perform operations described herein. Data area 1120 holds data used to perform operations described herein. Memory 1104 also includes other logic and storage 1130 that performs or facilitates other functions disclosed herein or otherwise required of computing device 1100. An input/output (I/O) component 1140 facilitates receiving input from users and other devices and generating displays for users and outputs for other devices. A network interface 1150 permits communication over external computer network 1160 with a remote node 1170, which may represent another implementation of computing device 1100. For example, a remote node 1170 may represent another of the above-noted nodes within architecture 100.

### Additional Examples

An example system comprises: a processor; and a computer-readable medium storing instructions that are operative upon execution by the processor to: based on at least determining that a first radio site is unable to meet demand for service, identify a second radio site that is able to perform a first antenna pointing adjustment to meet at least a portion of the demand for service of the first radio site; determine a first antenna pointing adjustment parameter value for an antenna of the second radio site for meeting the portion of the demand for service of the first radio site; and adjust the antenna of the second radio site from an initial pointing direction to a new pointing direction using the first antenna pointing adjustment parameter value.

An example method of wireless communication comprises: based on at least determining that a first radio site is unable to meet demand for service, identifying a second radio site that is able to perform a first antenna pointing adjustment to meet at least a portion of the demand for service of the first radio site; determining a first antenna pointing adjustment parameter value for an antenna of the second radio site for meeting the portion of the demand for service of the first radio site; and adjusting the antenna of the second radio site from an initial pointing direction to a new pointing direction using the first antenna pointing adjustment parameter value.

One or more example computer storage devices has computer-executable instructions stored thereon, which, upon execution by a computer, cause the computer to perform operations comprising: based on at least determining that a first radio site is unable to meet demand for service, identifying a second radio site that is able to perform a first antenna pointing adjustment to meet at least a portion of the demand for service of the first radio site; determining a first antenna pointing adjustment parameter value for an antenna of the second radio site for meeting the portion of the demand for service of the first radio site; and adjusting the antenna of the second radio site from an initial pointing direction to a new pointing direction using the first antenna pointing adjustment parameter value.

Alternatively, or in addition to the other examples described herein, examples include any combination of the following:
the wireless network comprises a cellular network;
the radio sites comprise cell sites or cell clusters;
based on at least determining that the second radio site is unable to meet demand for service upon adjusting the antenna of the second radio site from its initial pointing direction to its new pointing direction, identifying a third radio site that is able to perform a second antenna pointing adjustment to meet at least a portion of the demand for service of the second radio site;
determining a second antenna pointing adjustment parameter value for an antenna of the third radio site for meeting the portion of the demand for service of the second radio site;
adjusting the antenna of the third radio site from an initial pointing direction to a new pointing direction using the second antenna pointing adjustment parameter value;
the first antenna pointing adjustment comprises a mechanical antenna pointing adjustment;
the first antenna pointing adjustment comprises an electrical antenna pointing adjustment;
the second antenna pointing adjustment comprises a mechanical antenna pointing adjustment;
the second antenna pointing adjustment comprises an electrical antenna pointing adjustment;
identifying the second radio site comprises identifying the second radio site in an antenna pointing adjustment coverage data set;
building the antenna pointing adjustment coverage data set for a plurality of radio sites, including the second radio site and the third radio site;
building the antenna pointing adjustment coverage data set comprises, for each radio site included in the antenna pointing adjustment coverage data set, determining radio coverage as a function of the antenna pointing adjustment parameter value from a minimum antenna pointing adjustment parameter value for that radio site through a maximum antenna pointing adjustment parameter value for that radio site;
building the antenna pointing adjustment coverage data set comprises using crowdsourced radio signal quality measurements;
the first antenna pointing adjustment parameter value comprises a tilt angle or a tilt angle change;
the first antenna pointing adjustment parameter value comprises an azimuth angle or an azimuth angle change;
the first antenna pointing adjustment parameter value comprises a beam steering angle, a beam steering angle change, an array element phase, or an array element phase change;
upon reduction of unmet demand for service of the first radio site, returning the antenna of the second radio site to its initial pointing direction or its default position;
for each radio site included in the antenna pointing adjustment coverage data set, building the antenna pointing adjustment coverage data set for that radio site based on at least a trigger event;
the trigger event comprises occurrence of a low traffic condition;
for each radio site included in the antenna pointing adjustment coverage data set, determining the minimum antenna pointing adjustment parameter value for that radio site and the maximum antenna pointing adjustment parameter value for that radio site;
for each radio site included in the antenna pointing adjustment coverage data set, the antenna pointing adjustment coverage data set includes coverage for that radio site's default pointing direction;
monitoring for any radio site to be unable to meet demand for service;
determining that the first radio site is unable to meet demand for service;
the first radio site is unable to meet demand for service due to a network service activity;
the first radio site is unable to meet demand for service due to an unplanned outage;
the first radio site is unable to meet demand for service due to the demand for service exceeding a service capacity of the first radio site;
the mechanical antenna pointing adjustment comprises a tilt angle adjustment;
the mechanical antenna pointing adjustment comprises an azimuth angle adjustment;
the electrical antenna pointing adjustment comprises beamforming;
the beamforming uses an antenna array with displaced phase centers and a phase adjustment;
the second antenna pointing adjustment parameter value comprises: a tilt angle or tilt angle change; an azimuth angle or azimuth angle change; or a beam steering angle, beam steering angle change, array element phase, or array element phase change;
updating the antenna pointing adjustment coverage data set, using crowdsourced radio signal quality measurements, while the antenna of the second radio site is in its new pointing direction;
updating the antenna pointing adjustment coverage data set, using crowdsourced radio signal quality measurements, while the antenna of the third radio site is in its new pointing direction;
upon reduction of unmet demand for service of the first radio site, returning the antenna of the third radio site to its initial pointing direction or its default position;
for each of the second radio site and the third radio site, each radio site's initial pointing direction is a default pointing direction;
AI determines the first antenna pointing adjustment parameter value and/or the second antenna pointing adjustment parameter value; and
the network service activity comprises an activity selected from the list consisting of: frequency retuning, a software upgrade, maintenance, and a hardware upgrade.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of wireless communication, the method comprising:
based on at least determining that a first radio site is unable to meet demand for service, identifying a second radio site that is able to perform a first antenna pointing adjustment to meet at least a portion of the demand for service of the first radio site;
determining a first antenna pointing adjustment parameter value for an antenna of the second radio site for meeting the portion of the demand for service of the first radio site; and
adjusting the antenna of the second radio site from an initial pointing direction to a new pointing direction using the first antenna pointing adjustment parameter value.

2. The method of claim 1, further comprising:
based on at least determining that the second radio site is unable to meet demand for service upon adjusting the antenna of the second radio site from the initial pointing direction to its new pointing direction, identifying a third radio site that is able to perform a second antenna pointing adjustment to meet at least a portion of the demand for service of the second radio site;
determining a second antenna pointing adjustment parameter value for an antenna of the third radio site for meeting the portion of the demand for service of the second radio site; and
adjusting the antenna of the third radio site from an initial pointing direction to a new pointing direction using the second antenna pointing adjustment parameter value.

3. The method of claim 2, wherein the first antenna pointing adjustment comprises a mechanical antenna pointing adjustment and/or an electrical antenna pointing adjustment, and wherein the second antenna pointing adjustment comprises a mechanical antenna pointing adjustment and/or an electrical antenna pointing adjustment.

4. The method of claim 1, wherein identifying the second radio site comprises identifying the second radio site in an antenna pointing adjustment coverage data set, and wherein the method further comprises:
building the antenna pointing adjustment coverage data set for a plurality of radio sites, including the second radio site, wherein building the antenna pointing adjustment coverage data set comprises:
for each radio site included in the antenna pointing adjustment coverage data set, determining radio coverage as a function of the antenna pointing adjustment parameter value from a minimum antenna pointing adjustment parameter value for that radio site through a maximum antenna pointing adjustment parameter value for that radio site.

5. The method of claim 4, wherein building the antenna pointing adjustment coverage data set comprises using crowdsourced radio signal quality measurements.

6. The method of claim 1, wherein the first antenna pointing adjustment parameter value comprises:
a tilt angle or a tilt angle change;
an azimuth angle or an azimuth angle change; or
a beam steering angle, a beam steering angle change, an array element phase, or an array element phase change.

7. The method of claim 1, further comprising:
upon reduction of unmet demand for service of the first radio site, returning the antenna of the second radio site to its initial pointing direction or its default position.

8. A system comprising:
a processor; and
a computer-readable medium storing instructions that are operative upon execution by the processor to:
based on at least determining that a first radio site is unable to meet demand for service, identify a second radio site that is able to perform a first antenna pointing adjustment to meet at least a portion of the demand for service of the first radio site;
determine a first antenna pointing adjustment parameter value for an antenna of the second radio site for meeting the portion of the demand for service of the first radio site; and
adjust the antenna of the second radio site from an initial pointing direction to a new pointing direction using the first antenna pointing adjustment parameter value.

9. The system of claim 8, wherein the instructions are further operative to:
based on at least determining that the second radio site is unable to meet demand for service upon adjusting the antenna of the second radio site from its initial pointing direction to its new pointing direction, identify a third radio site that is able to perform a second antenna pointing adjustment to meet at least a portion of the demand for service of the second radio site;
determine a second antenna pointing adjustment parameter value for an antenna of the third radio site for meeting the portion of the demand for service of the second radio site; and
adjust the antenna of the third radio site from an initial pointing direction to a new pointing direction using the second antenna pointing adjustment parameter value.

10. The system of claim 9, wherein the first antenna pointing adjustment comprises a mechanical antenna pointing adjustment and/or an electrical antenna pointing adjustment, and wherein the second antenna pointing adjustment comprises a mechanical antenna pointing adjustment and/or an electrical antenna pointing adjustment.

11. The system of claim 8, wherein identifying the second radio site comprises identifying the second radio site in an antenna pointing adjustment coverage data set, and wherein the instructions are further operative to:
build the antenna pointing adjustment coverage data set for a plurality of radio sites, including the second radio site, wherein building the antenna pointing adjustment coverage data set comprises:
for each radio site included in the antenna pointing adjustment coverage data set, determining radio coverage as a function of the antenna pointing adjustment parameter value from a minimum antenna pointing adjustment parameter value for that radio site through a maximum antenna pointing adjustment parameter value for that radio site.

12. The system of claim 11, wherein building the antenna pointing adjustment coverage data set comprises using crowdsourced radio signal quality measurements.

13. The system of claim 8, wherein the first antenna pointing adjustment parameter value comprises:
a tilt angle or a tilt angle change;
an azimuth angle or an azimuth angle change; or
a beam steering angle, a beam steering angle change, an array element phase, or an array element phase change.

14. The system of claim 8, wherein the instructions are further operative to:
upon reduction of unmet demand for service of the first radio site, return the antenna of the second radio site to its initial pointing direction or its default position.

15. One or more computer storage devices having computer-executable instructions stored thereon, which, upon execution by a computer, cause the computer to perform operations comprising:
based on at least determining that a first radio site is unable to meet demand for service, identifying a second radio site that is able to perform a first antenna pointing adjustment to meet at least a portion of the demand for service of the first radio site;
determining a first antenna pointing adjustment parameter value for an antenna of the second radio site for meeting the portion of the demand for service of the first radio site; and
adjusting the antenna of the second radio site from an initial pointing direction to a new pointing direction using the first antenna pointing adjustment parameter value.

16. The one or more computer storage devices of claim 15, wherein the operations further comprise:
based on at least determining that the second radio site is unable to meet demand for service upon adjusting the antenna of the second radio site from its initial pointing direction to its new pointing direction, identifying a third radio site that is able to perform a second antenna pointing adjustment to meet at least a portion of the demand for service of the second radio site;
determining a second antenna pointing adjustment parameter value for an antenna of the third radio site for meeting the portion of the demand for service of the second radio site; and
adjusting the antenna of the third radio site from an initial pointing direction to a new pointing direction using the second antenna pointing adjustment parameter value.

17. The one or more computer storage devices of claim 16, wherein the first antenna pointing adjustment comprises a mechanical antenna pointing adjustment and/or an electrical antenna pointing adjustment, and wherein the second antenna pointing adjustment comprises a mechanical antenna pointing adjustment and/or an electrical antenna pointing adjustment.

18. The one or more computer storage devices of claim 15, wherein identifying the second radio site comprises identifying the second radio site in an antenna pointing adjustment coverage data set, and wherein the operations further comprise:
building the antenna pointing adjustment coverage data set for a plurality of radio sites, including the second radio site, wherein building the antenna pointing adjustment coverage data set comprises:
for each radio site included in the antenna pointing adjustment coverage data set, determining radio coverage as a function of the antenna pointing adjustment parameter value from a minimum antenna pointing adjustment parameter value for that radio site through a maximum antenna pointing adjustment parameter value for that radio site.

19. The one or more computer storage devices of claim 18, wherein building the antenna pointing adjustment coverage data set comprises using crowdsourced radio signal quality measurements.

20. The one or more computer storage devices of claim 15, wherein the first antenna pointing adjustment parameter value comprises:
a tilt angle or a tilt angle change;
an azimuth angle or an azimuth angle change; or
a beam steering angle, a beam steering angle change, an array element phase, or an array element phase change.
